(19) United States
(12) Patent Application Publication
(10) Pub. No.: US 2006/0196283 A1
(43) Pub. Date: Sep. 7, 2006

(54) Measurement of Thickness Profile and Elastic Modulus Profile of a Polishing Pad

(76) Inventors: Kai Yang, San Jose, CA (US); Sheng-Hun Jeng, Hsin-Chu Hsien (TW); Yu-Ting Lin, Tai-Chung Hsien (TW)

Correspondence Address: NORTH AMERICA INTELLECTUAL PROPERTY CORPORATION, P.O. BOX 506, MERRIFIELD, VA, 22116, US

(21) Appl. No.: 11/306,766

(22) Filed: Jan. 10, 2006

(30) Foreign Application Priority Data
Jan. 11, 2005 (TW) 094100732

(51) Int. Cl. G01N 19/00; B24B 49/00

(52) U.S. Cl. 73/865.9; 451/8

(57) ABSTRACT

An apparatus for measuring the thickness profile and elastic modulus profile of a polishing pad comprise an eddy current sensor and a mechanism to press the eddy current sensor against the polishing pad. The pad thickness is given by the signal of the eddy current sensor. The elastic modulus of the polishing pad is extracted from measurements at different forces applied to the eddy current sensor. The thickness profile and elastic modulus profile of the polishing pad are obtained by scanning the measurement across the whole polishing pad or along a diameter of the polishing pad. The pad thickness profile is used to adjust pad conditioning recipe so that more pad materials is eroded away at thicker area of the pad. By employing the apparatus of present invention, the thickness uniformity of a polishing pad can be better maintained, resulting in longer pad lifetime and better CMP removal rate uniformity.

### BACKGROUND OF THE INVENTION

1. Field of the Invention

The present invention relates to a measurement device, and more particularly, to a device for measuring the thickness profile and elastic modulus profile of a polishing pad surface.

2. Description of the Prior Art

Chemical-mechanical polishing (CMP) is a process that is nowadays widely used in manufacturing semiconductor integrated circuits. Because of its superior ability to planarize wafer, CMP has many applications in semiconductor wafer processing. One of the applications of CMP is to planarize the dielectric layer between interconnect metal layers. Another application of CMP is in the formation of metal lines and vias through a damascene process. A further application of CMP is in the formation of shallow trench isolation (STI) between transistors. New applications for CMP in semiconductor processing are still being identified.

During a CMP process as shown in FIG. 1, the wafer carrier 16 holds the semiconductor wafer 19 and applies a pressure to the back side of the wafer 19 while the front side of the wafer 19 is in contact with the polishing pad 14. The wafer carrier rotates in the same direction as the polishing pad 14 mounted on platen 13. The slurry 18 is dispersed to the surface of the polishing pad 14 while wafer is being polished. The combined chemical and mechanical effects result in the planarization of the wafer surface.

The polishing pad 14 is generally made of polymers such as porous polyurethane. A diamond disk 13, which is often termed as “pad conditioner” in the art of CMP, is often used to roughen the pad surface after each wafer polishing in order keep CMP removal rate constant. In the CMP process, the polishing pad 14 is repetitively stressed and worn by the semiconductor wafers and the pad conditioner 13, causing the pad thickness and elastic properties to gradually become uneven. The uneven pad thickness and elastic properties result in deterioration of the uniformity of the CMP removal rate across the wafer. When the uniformity of the CMP removal rate reaches a limit of process specification, the polishing pad must be discarded and replaced by a new one.

In order to solve the above-mentioned problems, several methods have been proposed to detect the usage condition of the polishing pad 14. U.S. Pat. No. 5,951,370 issued to Cesna et al, U.S. Pat. No. 6,194,231 issued to Ho-Cheng et al, U.S. Pat. No. 5,934,974 issued to Tzeng, and U.S. Pat. No. 5,609,718 issued to Meikle teach various optical methods to measure pad thickness profile. U.S. Pat. No. 6,045,434 issued to Fisher et al. describes a method using interferometer with ultrasonic or electromagnetic waves as a radiation source.

The optical methods described in the prior art generally can not achieve accurate pad thickness measurement because the polishing pad 14 has a rough surface and is often semi-transparent. Another deficiency of the prior art is that it only can measure the free-standing pad thickness, namely, pad thickness when no external pressure is applied. Since the polishing pad 14 is under a pressure during wafer polishing, the pad thickness under pressure would be more relevant to the polishing removal rate uniformity. None of the methods in the prior art can be used to measure the elastic modulus profile of the polishing pad 14, which is another important physical property that has significant impact on CMP uniformity.

### SUMMARY OF THE INVENTION

An objective of the present invention is to provide an apparatus and a method to accurately measure the thickness profile and elastic modulus profile of the polishing pad, thereby monitoring the usage condition of the polishing pad.

Another objective of the present invention is to use the measurement data of pad thickness and elastic modulus profile for the adjustment of the pad conditioning recipe in order to effectively maintain the uniformity of CMP removal rate across the wafer.

According to the present invention, the apparatus includes a unit that can generate a specified force. The force generating unit may comprise an actuator and a force sensor. A controller drives the actuator, the actuator applies a force to the force sensor, and the force sensor detects the magnitude of the force applied by the actuator and provides a feedback signal to the controller for precisely controlling the applied force. Additionally, the apparatus also includes a distance sensor, which is connected to the other end of force sensor through a transmission unit 40, for measuring the thickness profile of the polishing pad surface. The distance sensor is preferably an eddy current sensor. From the measurement of pad thickness profiles at two or more applied pressures, the profile of elastic modulus can be derived.

By utilizing the apparatus of the present invention, the thickness profile and elastic modulus profile can be precisely measured. Using the feedback of measured data, the pad conditioning recipe can be constantly adjusted to maintain the CMP uniformity and therefore extend the polishing pad life time.

An essential difference between the present invention and the prior art is that the present invention uses platen surface as the reference plane for the pad surface profile measurement and has measurement sensor directly in contact with pad surface. Since CMP platen has high degree of flatness, it allows precise measurement of the pad surface profile.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a perspective diagram showing the structure of a chemical mechanical polishing device.

FIG. 2 is a block diagram showing the function of an apparatus according to the present invention.

FIG. 3 is a perspective diagram of the apparatus from FIG. 2.

FIG. 4 is a block diagram showing the function of the apparatus according to another embodiment of the present invention.

### DETAILED DESCRIPTION

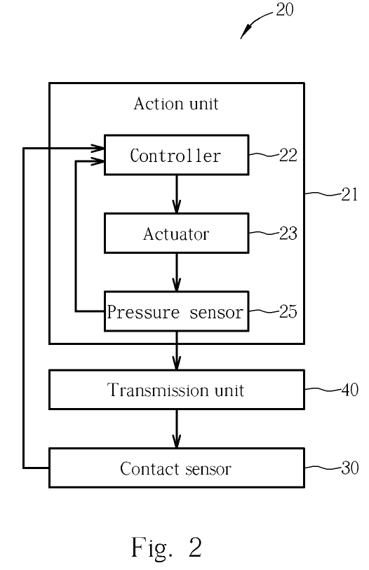

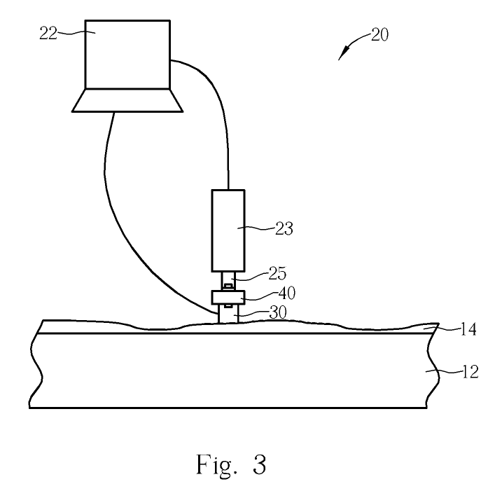

Please refer to FIG. 2 and FIG. 3. FIG. 2 is a block diagram showing the function of an apparatus 20 according to the present invention and FIG. 3 is a perspective diagram of the apparatus 20. As showing in FIG. 2 and FIG. 3, the apparatus 20 includes a force generation unit which may comprise an actuator 23 and a force sensor 25. The controller 22 drives the actuator 23, the actuator 23 exerts a force to the force sensor 25, and the force sensor 25 detects the magnitude of the force exerted by the actuator 23 and provides a feedback signal to the controller 22 for precisely controlling the applied force. Additionally, the apparatus 20 also includes a distance sensor 30 for measuring the distance between the surface of a particular area on the polishing pad 14 and the polishing platen 12. The apparatus may further comprise a transmission unit 40 for transmitting the force provided by the actuator 23 to the distance sensor 30. The force applied by actuator causes distance sensor to press against a particular area on the polishing pad and the distance sensor measures the distance between the sensor and the platen surface underneath the polishing pad. The measured distance is exactly the thickness of the said area of the polishing pad under the pressure applied by the distance sensor since the sensor in contact with pad. The measured pad thickness decreases when the applied pressure increases. The ratio of the variation of the pad thickness over the variation of the applied pressure is the elastic modulus of the pad. The elastic modulus can also be obtained from the slope in the pad thickness versus pressure plot through linear regression method. The aforementioned measurement can be conducted at different locations of the pad to give the thickness profile and elastic modulus profile across the entire pad 14.

Due to the fact that the pad thickness variations at different pad locations are small, typically in the order of a few microns, the distance sensor used in the present invention should have high precision. The distance sensor used in the present invention can be an eddy current distance sensor, ultrasonic distance sensor, capacitive distance sensor, or other type of distance sensor. The most preferred distance sensor is an eddy current distance sensor because it provides high precision and the measurement results are less affected by the water or slurry content in the porous polishing pad. When eddy current distance sensor is used, the pad thickness variation of less than one micron can be detected. The distance sensor surface which contacts with the polishing pad is preferably made of a material that is electrically insulating, resistant to mechanical wearing, and resistant to chemical attack. Said material can be diamond, silicon carbide, aluminum oxide, zirconium oxide, Teflon, etc.

The actuator 23 can comprise a stepping motor, a servomotor, or other kinds of mechanical motion driver. The actuator 23 can optionally comprise a high threshold sensor and/or a low threshold sensor for limiting the size of the force provided by the actuator 23. The force sensor 25 can be a load cell of strain-gage type or piezoelectric type, capacitive force transducer, or force sensing resistor. The transmission unit 40 can be a linear track or other type of device that can transmit force. The transmission unit 40 may optionally include a spring so that the applied force can be stabilized and allows a larger actuator movement range for a specified force. The controller 22 is connected to the actuator 23, the force sensor 25, and the distance sensor 30. The controller 22 may include an electronic driving circuit for actuator, analogue-to-digital converters for digitizing the electrical signal from the force sensor 25 and the distance sensor 30, a microprocessor or other type of computing device, a display device for measurement results, and a communication device for exchanging data with the main computer of the polisher.

The present invention allows the measurement of pad thickness and elastic modulus to be conducted at discrete locations of the pad or in a continuous scan over the entire pad. For instance, a plurality of eddy current sensors can be aligned along the radial direction of the polishing pad 14 so that each eddy current sensor can scan and measure along the circle of the specific radius on the pad when the polishing platen 13 rotates.

Alternatively, the apparatus 20 of the present invention can be used together with a horizontal moving device for driving the apparatus 20 along a radial direction or a substantially radial direction of the polishing pad 14. The combination of the rotation of polishing platen 12 and radial movement of the apparatus allows measurement to be conducted at any locations of the pad.

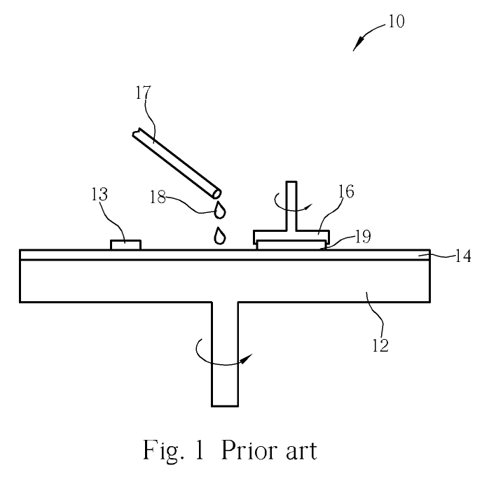

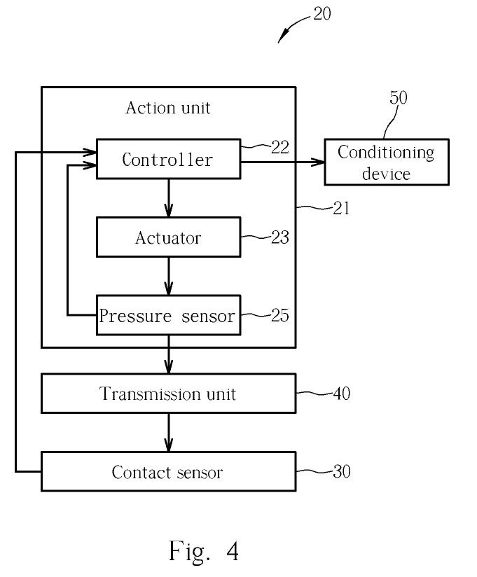

FIG. 4 is a block diagram showing another embodiment of the present invention. In contrast to the previous embodiment, the controller 22 of the present embodiment is connected to a conditioner driver 50 that controls the movement of conditioner 13 shown in FIG. 1. The measured data of the pad thickness profile and elastic modulus profile are used to optimize the manner of conditioner movement. In the art of CMP, the manner of the conditioner movement is often termed as “conditioning recipe”. The conditioning recipe can be constantly adjusted according to the measurement data so that the conditioner erodes more pad materials at thicker area to maintain pad thickness uniformity. Consequently, the within-wafer uniformity of CMP removal rate can be better maintained, resulting in higher semiconductor device production yield.

In another embodiment of present invention is to use gravitational force to apply a pressure on the pad, which simplifies mechanical complexity of the apparatus of present invention. In this embodiment, the actuator 23 and force sensor 25 in FIG. 2-4 are replaced by one piece or multiple pieces of masses with known weights. Preferably, said masses are made of high density metals, such as steel, copper, tungsten, etc. so that the volume of the apparatus can be kept small. The pressure applied to the pad depends on the weight of the masses placed in the apparatus and weights of other parts of the apparatus. The required specific pressure applied to the pad can be obtained by selecting said masses with appropriate weight.

The present invention not only can be used in the CMP process of semiconductor wafer fabrication but also can be used in the quality control of CMP pad production and development of CMP pad products. For example, the apparatus of present invention can be used to select polymer materials used in the manufacturing CMP pad so that the elastic properties of the pad can have better stability under repetitive stress and slurry soaking.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An apparatus for measuring the thickness profile and elastic modulus profile of a polishing pad comprising:
(a) at least one distance sensor;
(b) a mechanism for applying a force to said distance sensor so that said distance sensor presses against the surface of said polishing pad that is mounted on a platen; and
(c) a controller with electronic circuit capable of processing electrical signals from distance sensor.

2. The apparatus of claim 1, wherein said platen is a polishing platen of a CMP polisher.

3. The apparatus of claim 1, wherein said distance sensor measures the distance between said distance sensor and the surface of said platen when said distance sensor presses on the surface of said polishing pad, thereby the thickness of said polishing pad under the pressure exerted by said distance sensor is obtained from the measured distance.

4. The apparatus of claim 1, wherein said distance sensor is an eddy current distance sensor, a capacitive distance sensor, or an ultrasonic distance sensor.

5. The apparatus of claim 1, wherein said distance sensor is an eddy current distance sensor and said platen is made of metal.

6. The apparatus of claim 1, wherein the elastic modulus of said polishing pad is obtained from the ratio of the variation of the pad thickness over the variation of pressure applied to said pad, or from the slope of the pad thickness versus pressure plot through linear regression method.

7. The apparatus of claim 1, wherein the thickness and elastic modulus are measured while said polishing pad is still or rotating.

8. The apparatus of claim 1, wherein the magnitude of said force is set to a value so that the pressure exerted on said polishing pad is equal to or close to the magnitude of the pressure applied to the said pad by the wafer during polishing.

9. The apparatus of claim 1 is driven by a horizontal moving device to move along a radial direction or a substantially radial direction of said polishing pad.

10. The apparatus of claim 9, wherein the radial movement of said apparatus is combined with the rotation of said platen allowing the measurement of the pad thickness and elastic modulus at different locations, and thereby the profiles of the pad thickness and elastic modulus.

11. The apparatus of claim 1, wherein a plurality of distance sensors are located at different radii on the polishing pad for simultaneous measurement of pad thickness at different radii on the pad.

12. The apparatus of claim 1, wherein said mechanism comprises an actuator, a force sensor, and a transmission unit.

13. The apparatus of claim 12, wherein said actuator is driven by an electrical motor, a pneumatic piston, or a hydraulic piston, and the force sensor detects the magnitude of the applied force and provide a feedback signal to said controller for precise control of the applied force.

14. The apparatus of claim 12, wherein the actuator further comprises a high threshold sensor and/or a low threshold sensor for limiting the size of the force provided by the actuator.

15. The apparatus of claim 12, wherein the force sensor comprises a load cell.

16. The apparatus of claim 15, wherein the load cell further comprises a strain-gate type load cell or a piezoelectric type load cell.

17. The apparatus of claim 1 further comprising a transmission unit for transmitting the force to the eddy current sensor.

18. The apparatus of claim 17, wherein the transmission unit is a linear track.

19. The apparatus of claim 17, wherein the transmission unit comprises a spring to stabilize the applied force and allows larger movement range for the actuator at a specified force.

20. The apparatus of claim 1, wherein the surface of the polishing pad is sprayed with CMP slurry.

21. The apparatus of claim 1, wherein said force is the gravitational weight of the apparatus and the weight of apparatus is adjustable by adding or removing masses with known weight.

22. The apparatus of claim 1 further comprise a driver for pad conditioner.

23. The apparatus of claim 1 is mounted on a CMP polisher or is a stand alone apparatus.

24. A method of measuring and maintaining the thickness profile of a polishing pad comprising:
(a) mounting a polishing pad on a metal platen;
(b) providing at least a distance sensor that can detect the distance from said metal platen surface to said distance sensor;
(c) applying a force to press said distance sensor against the surface of said polishing pad;
(d) using said distance sensor to scan over the polishing pad surface to measure the pad thickness profile at pressures that is equal to or close to the pressure applied by the wafer on said pad during polishing; and
(e) adjusting pad conditioning recipe according to the measured pad thickness profile so that the conditioner erodes more pad materials at the thicker area of the pad to maintain pad thickness uniformity.

25. The method of claim 24, wherein the distance sensor is an eddy current distance sensor.

26. The method of claim 24, wherein the pad thickness measurement and conditioning recipe adjustment are conducted after polishing every single wafer or after polishing a group of wafers.
